(19) United States
(12) Patent Application Publication
(10) Pub. No.: US 2007/0157834 A1
(43) Pub. Date: Jul. 12, 2007

(54) Stamp with a pattern exhibiting a three-dimensional visual effect and method for producing the same

(76) Inventor: Kuo Wen Hwang, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/328,185

(22) Filed: Jan. 10, 2006

(51) Int. Cl. B32B 37/00; B41G 7/00; B29C 65/00

(52) U.S. Cl. 101/368; 156/297

(57) ABSTRACT

A method for producing a stamp with a pattern includes deciding a design, the design including three sections separated by three imaginary lines that intersect with one another at a common imaginary point, the design being distributed in the three sections and exhibiting a three-dimensional visual effect; and processing an end of a stamp to form a pattern according to the design, with the pattern exhibiting a three-dimensional visual effect. The stamp includes a body with an end face. The end face includes a pattern having three sections separated by three imaginary lines that intersect with one another at a common imaginary point. The pattern exhibits a three-dimensional visual effect.

### BACKGROUND OF THE INVENTION

1. Field of the Invention

The present invention relates to a stamp with a pattern exhibiting a three-dimensional visual effect. The present invention also relates to a method for producing such a stamp.

2. Description of the Related Art

Seals have been used for centuries for identifying the writer, the painter, or the artist of a work of art. Seals with specific patterns and/or carving have also been used as national seals. Seal processing or work has a long history in China, Korea, and Japan. An end of a seal is processed to create beautiful artistic recessed or protruded Chinese characters, drawing, symbols, etc (hereinafter all referred to as “pattern”). Nowadays an enterprise, company, or a person uses seals with specific patterns for marking, anti-forging, and/or advertisement.

FIG. 1 shows a conventional seal 1 having an end face 11 with a recessed section in which protruded Chinese characters are formed. Chinese characters have various fonts after developments in centuries such that further development is difficult. Further, forging of seals becomes easy when using a computer-operated automatic seal-making machine.

### SUMMARY OF THE INVENTION

An objective of the present invention is to provide a stamp with a pattern exhibiting a three-dimensional visual effect. Such a pattern provides an anti-forging effect.

Another objective of the present invention is to provide a method for producing such a stamp.

A method for producing a stamp with a pattern exhibiting a three-dimensional visual effect in accordance with the present invention comprises deciding a design, the design including three sections separated by three imaginary lines that intersect with one another at a common imaginary point, the design being distributed in the three sections and exhibiting a three-dimensional visual effect; and processing an end of a stamp to form a pattern according to the design, with the pattern exhibiting a three-dimensional visual effect.

Preferably, the design is decided by a computer-operated pattern processing system.

Preferably, the end of the stamp is processed by a computer-operated three-axis automatic stamp-making machine.

Preferably, the method further comprises a step of manually finishing the pattern.

Preferably, the method further comprises a step of scanning a signature of a person to obtain a scanned image and a step of processing the scanned image to obtain the design.

Preferably, the method further comprises a step of printing out the design to form a negative picture.

Preferably, the stamp is a seal or a rubber stamp.

Preferably, the three imaginary lines together present a substantially figure Y.

Alternatively, the pattern is attached to the end face of the stamp by bonding.

A stamp in accordance with the present invention comprises a body with an end face. The end face comprises a pattern having three sections separated by three imaginary lines that intersect with one another at a common imaginary point. The pattern exhibits a three-dimensional visual effect.

Preferably, the end face comprises two opposite corners that are cut to form recessed sections.

Preferably, the end face comprises a first side, a second side, a third side, a fourth side, a fifth side, and a sixth side. The first side is parallel to the fourth side, the second side is parallel to the fifth side, and the third side is parallel to the sixth side. A first one of the three imaginary lines is parallel to and between the first side and the fourth side, a second one of the three imaginary lines is parallel to and between the second side and the fifth side, and a third one of the three imaginary lines is parallel to and between the third side and the sixth side. The three imaginary lines together present a substantially figure Y, thereby forming three sections each having recessed grooves that form a part of the pattern.

Preferably, the stamp comprises a body with a mark to indicate an orientation of the pattern.

Preferably, the body of the stamp extends to the end face and is a column with six faces.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of a conventional seal.

FIG. 2 is a flowchart illustrating a method for producing a stamp in accordance with the present invention.

FIG. 3 is a perspective view of a stamp produced by the method in accordance with the present invention.

FIG. 4 is an elevational view of an end face of a stamp before processing.

FIG. 5 is an elevational view illustrating imaginary lines for processing the end face of the stamp.

FIG. 6 is an elevational view illustrating a pattern on the end face of the stamp after processing.

FIG. 7 illustrates a stamping result of the pattern in FIG. 6.

FIG. 8 is an elevational view illustrating another example of the pattern.

FIG. 9 illustrates a stamping result of the pattern in FIG. 8.

FIG. 10 is an elevational view illustrating a further example of the pattern.

FIG. 11 illustrates a stamping result of the pattern in FIG. 10.

FIGS. 12-15 illustrate another example of the method for processing an end face of a stamp in accordance with the present invention.

FIG. 16 is an elevational view illustrating another example of the pattern.

FIG. 17 illustrates a stamping result of the pattern in FIG. 16.

FIG. 18 is a side view, partly sectioned, of the stamp produced by the method in accordance with the present invention.

FIG. 18A is an enlarged view of a circled portion in FIG. 18.

FIG. 19 is a perspective view illustrating a further example of the stamp produced by the method in accordance with the present invention.

FIGS. 20-24 illustrate different stamping results of different patterns of the stamps produced by the method in accordance with the present invention.

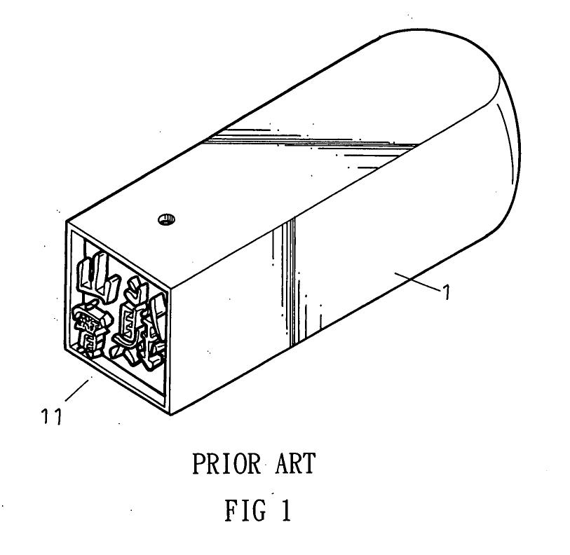

### DETAILED DESCRIPTION OF THE INVENTION

A method for producing a stamp with a pattern exhibiting a three-dimensional visual effect in accordance with the present invention comprises deciding a design, the design including three sections separated by three imaginary lines that intersect with one another at a common imaginary point, the design being distributed in the three sections and exhibiting a three-dimensional visual effect; and processing an end of a stamp to form a pattern according to the design, with the pattern exhibiting a three-dimensional visual effect.

The stamp is a seal, a rubber stamp, or any article that may be processed to form the required pattern and that can be used for imprinting purposes after applying ink or the like on the end face of the stamp.

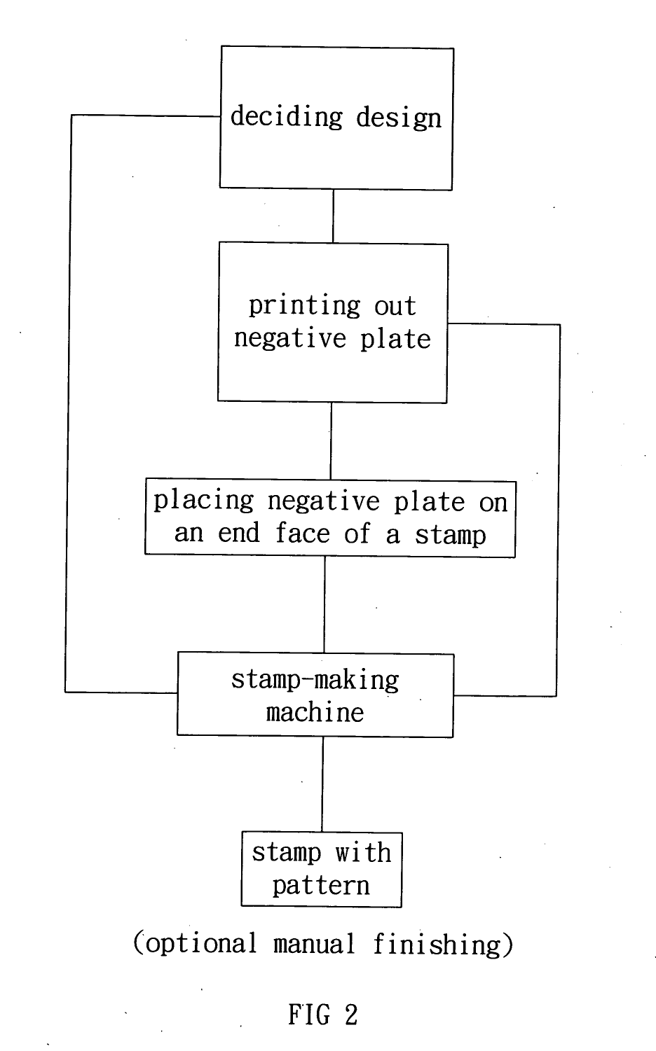

Referring to FIG. 2, in an example of the invention, the design is decided by a computer-operated pattern processing system. A negative picture of the design is made by printing. Next, the negative picture is placed on an end face of a stamp. The end face of the stamp is then processed by a computer-operated three-axis automatic stamp-making machine to form the required pattern. Alternatively, the pattern may be attached to the end face of the stamp by bonding. Optionally, manual finishing or trimming can be applied to the pattern on the end face of the stamp. The computer-operated three-axis automatic stamp-making machine is connected to or comprises the computer-operated pattern processing system.

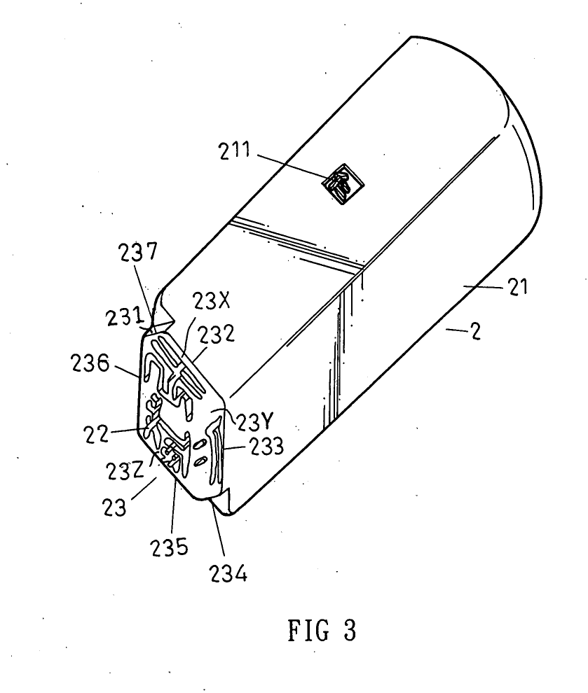

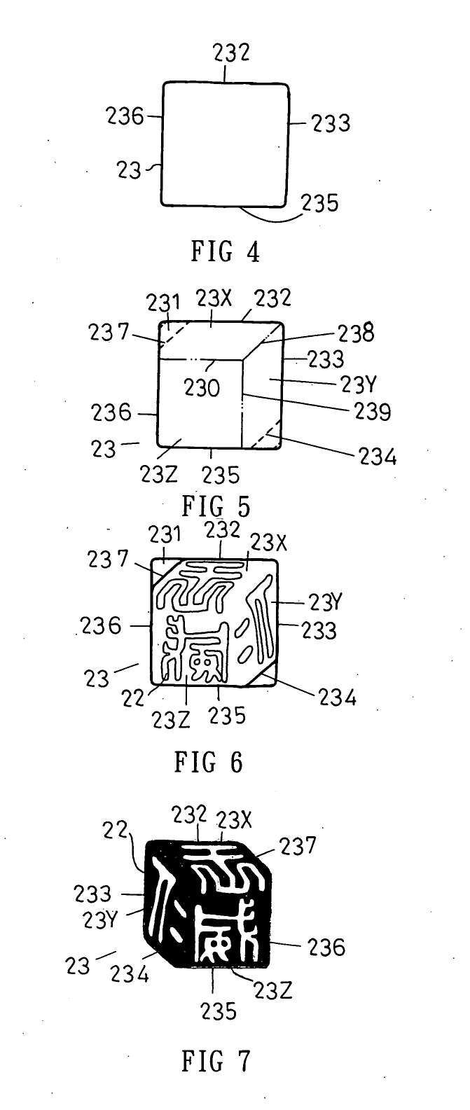

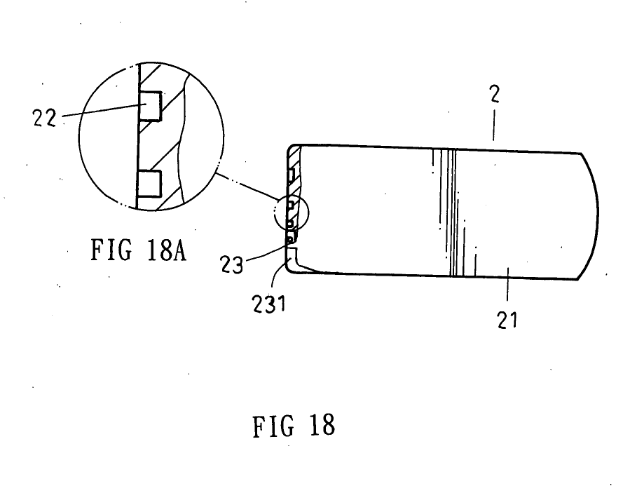

FIG. 3 is a perspective view of a stamp 2 produced by the method in accordance with the present invention. FIG. 4 is an elevational view of an end face 23 of a stamp 2 before processing. FIG. 5 is an elevational view illustrating imaginary lines 230, 238, and 239 for processing the end face 23 of the stamp. FIG. 6 is an elevational view illustrating a pattern 22 on the end face 23 of the stamp 2 after processing. FIG. 7 illustrates a stamping result of the pattern 22 in FIG. 6. FIG. 18 is a side view, partly sectioned, of the stamp 2 produced by the method in accordance with the present invention. FIG. 18A is an enlarged view of a circled portion in FIG. 18.

Referring to FIG. 3, the stamp 2 comprises a body 21 with a mark 211 to indicate an orientation of the pattern 22 on the end face 23 of the body 21. The pattern 22 includes drawings, letters, Chinese characters, etc. Preferably, two opposite corners (the upper left corner and the lower right corner in FIGS. 3 and 5) of the end face 23 are cut to form recessed sections 231 for preventing the user from being injured by sharp edges.

The end face 23 comprises six sides (three pairs) 232, 233, 234, 235, 236, and 237 (numbered along the clockwise direction), wherein the side 232 is parallel to the side 235, the side 233 is parallel to the side 236, and the side 234 is parallel to the side 237, and wherein an imaginary line 230 is parallel to and between the sides 232 and 235, an imaginary line 238 is parallel to and between the sides 234 and 237, and an imaginary line 239 is parallel to and between the sides 233 and 236. The three imaginary lines 238, 239, and 230 together present a substantially figure Y and intersect with one another at a common imaginary point. Three sections 23X, 23Y, and 23Z are thus formed, with each section 23X, 23Y, 23Z having recessed grooves that form a part of the pattern 22. Ink can be applied to the end face 23 of the stamp 22 for imprinting (or stamping) purposes. The imprinting or stamping result exhibits a three-dimensional visual effect, as shown in FIG. 7.

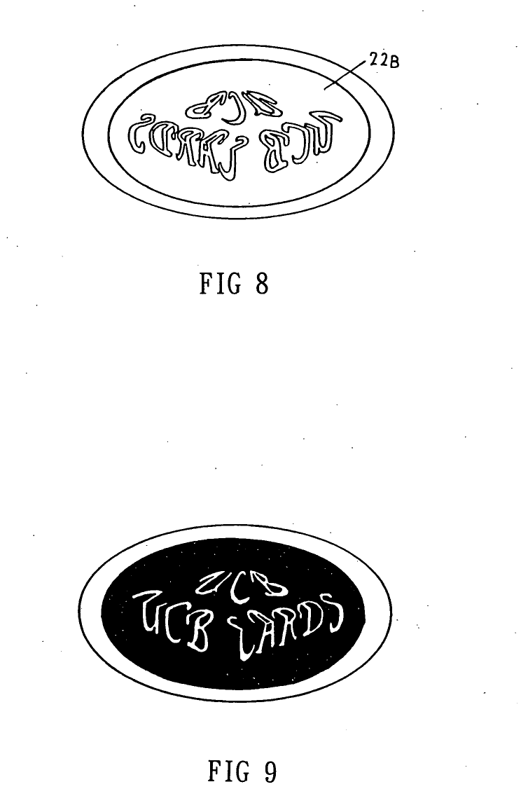

FIG. 8 is an elevational view illustrating another example of the pattern 22B. FIG. 9 illustrates a stamping result of the pattern 22B in FIG. 8. The pattern 22B includes letters or characters of any country and can be encompassed in an ellipse.

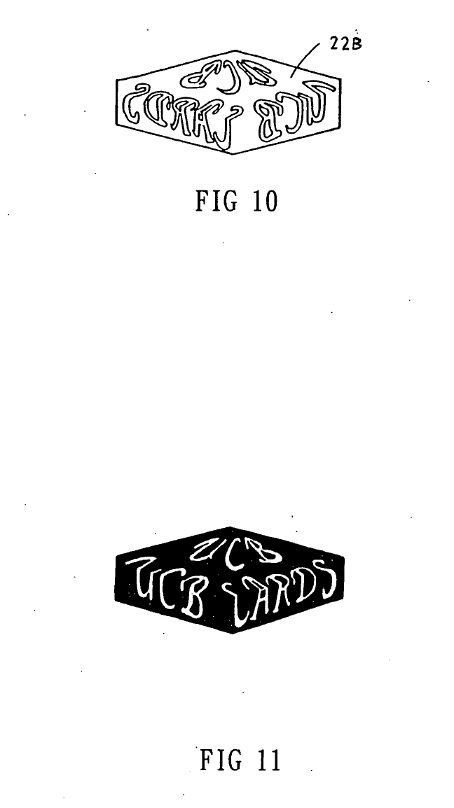

FIG. 10 is an elevational view illustrating a further example of the pattern 22B that is distributed in a rhombic manner. FIG. 11 illustrates a stamping result of the pattern 22B in FIG. 10.

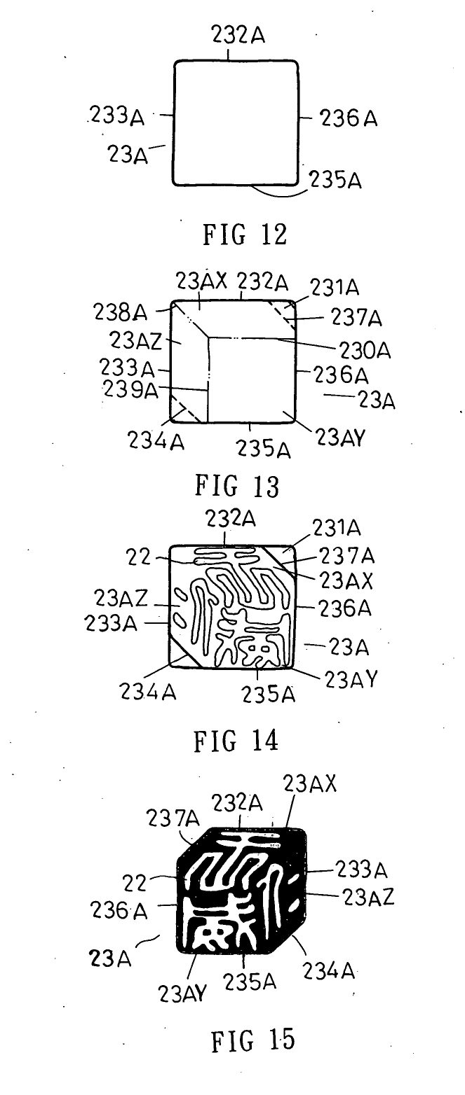

FIGS. 12-15 illustrate another example of the method for processing an end face 23A of a stamp 23 in accordance with the present invention.

Referring to FIG. 13, two opposite corners (the upper right corner and the lower left corner of the end face 23A are cut to form recessed sections 231A for preventing the user from being injured by sharp edges.

The end face 23A comprises six sides (three pairs) 232A, 233A, 234A, 235A, 236A, and 237A (numbered along the counterclockwise direction), wherein the side 232A is parallel to the side 235A, the side 233A is parallel to the side 236A, and the side 234A is parallel to the side 237A, and wherein an imaginary line 230A is parallel to and between the sides 232A and 235A, an imaginary line 238A is parallel to and between the sides 234A and 237A, and an imaginary line 239A is parallel to and between the sides 233A and 236A. The three imaginary lines 238A, 239A, and 230A together present a substantially figure Y and intersect with one another at a common imaginary point. Three sections 23AX, 23AY, and 23AZ are thus formed, with each section 23AX, 23AY, 23AZ having recessed grooves that form a part of the pattern 22. Ink can be applied to the end face 23A of the stamp for imprinting (or stamping) purposes. The imprinting or stamping result exhibits a three-dimensional visual effect, as shown in FIG. 15.

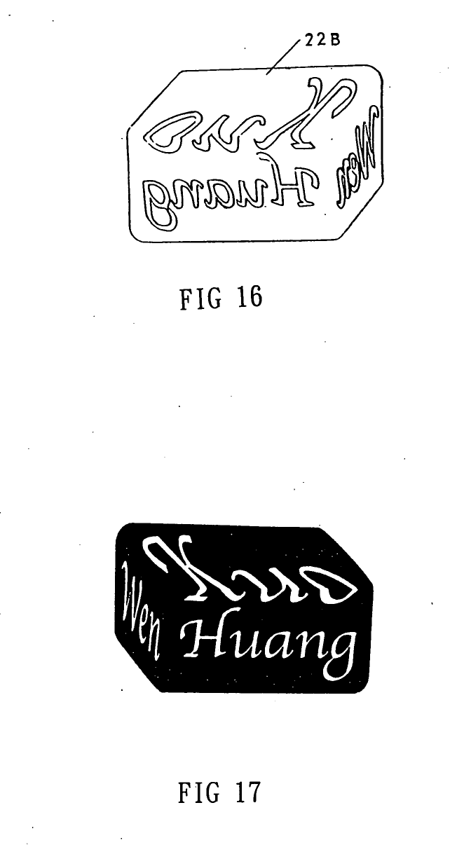

FIG. 16 is an elevational view illustrating another example of the pattern 22B encompassed by a polyhedral and including letters or characters of any country. FIG. 17 illustrates a stamping result of the pattern 22B in FIG. 16.

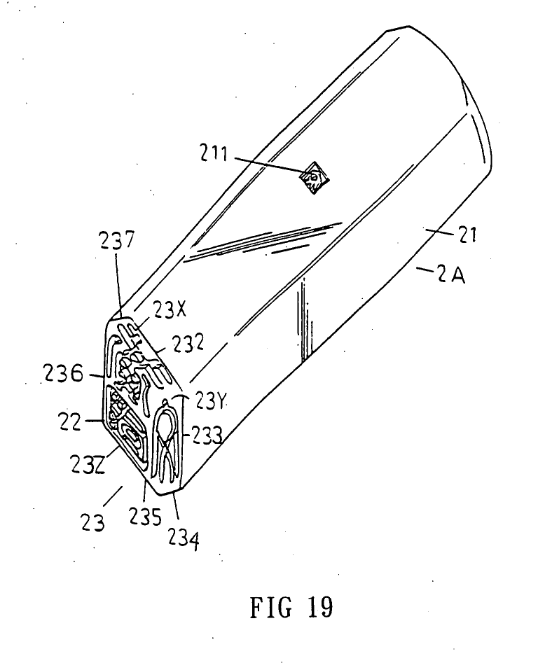

FIG. 19 is a perspective view illustrating a further example of the stamp 2A produced by the method in accordance with the present invention. The stamp 2A is a column with six sides and the body 21 extends to the end face 23. A pattern 22 exhibiting a three-dimensional visual effect can be formed on the end face 23 of the stamp 2A after carrying out the method in accordance with the present invention.

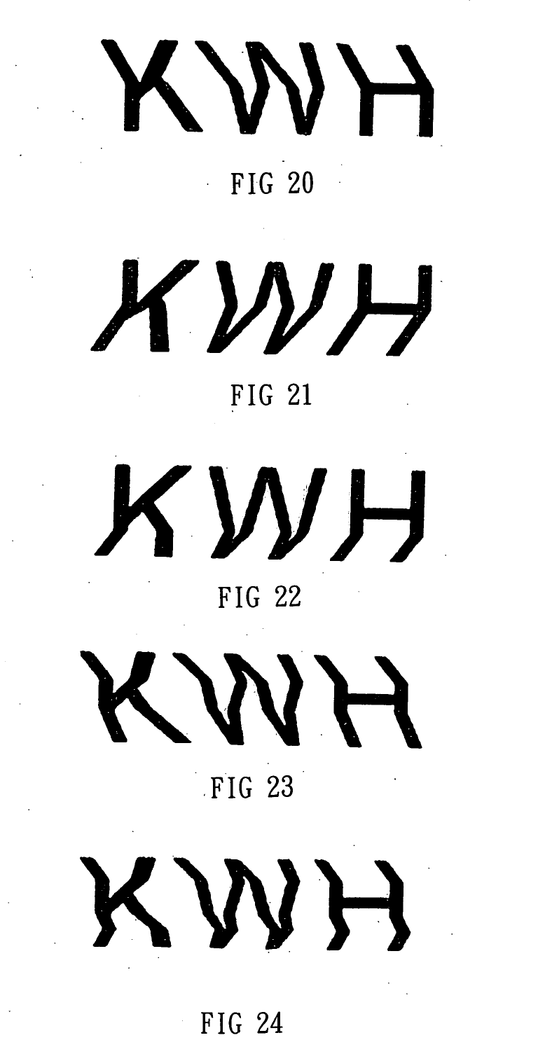

FIGS. 20-24 illustrate different stamping results of different patterns of the stamps produced by the method in accordance with the present invention.

As apparent from the foregoing, the pattern 22, 22B on the end face 23, 23A of the stamp 2, 2A provides an anti-forging effect in addition to an aesthetically pleasing effect. Further, the pattern 22, 22B can be used in other fields, such as on credit cards or as marks of an enterprise, providing added value. The pattern can be a signature by the user. The signature can be scanned into the computer-operated pattern-processing system to obtain a scanned image. The scanned image can be finished to obtain the design. The resultant pattern is more personal and further enhances the anti-forging effect.

Although specific embodiments have been illustrated and described, numerous modifications and variations are still possible without departing from the essence of the invention. The scope of the invention is limited by the accompanying claims.

What is claimed is:

1. A method for producing a stamp with a pattern exhibiting a three-dimensional visual effect, the method comprising:
deciding a design, the design including three sections separated by three imaginary lines that intersect with one another at a common imaginary point, the design being distributed in the three sections and exhibiting a three-dimensional visual effect; and
processing an end of a stamp to form a pattern according to the design, with the pattern exhibiting a three-dimensional visual effect.

2. The method as claimed in claim 1 wherein the design is decided by a computer-operated pattern processing system.

3. The method as claimed in claim 1 wherein the end of the stamp is processed by a computer-operated three-axis automatic stamp-making machine.

4. The method as claimed in claim 3 further comprising a step of manually finishing the pattern.

5. The method as claimed in claim 3 further comprising a step of scanning a signature of a person to obtain a scanned image and a step of processing the scanned image to obtain the design.

6. The method as claimed in claim 3 further comprising a step of printing out the design to form a negative picture.

7. The method as claimed in claim 1 wherein the stamp is a seal or a rubber stamp.

8. The method as claimed in claim 1 wherein the three imaginary lines together present a substantially figure Y.

9. The method as claimed in claim 1 wherein the pattern is attached to the end face of the stamp by bonding.

10. A stamp comprising a body with an end face, the end face comprising a pattern having three sections separated by three imaginary lines that intersect with one another at a common imaginary point, the pattern exhibiting a three-dimensional visual effect.

11. The stamp as claimed in claim 10 wherein the end face comprises two opposite corners that are cut to form recessed sections.

12. The stamp as claimed in claim 11 wherein the end face comprises a first side, a second side, a third side, a fourth side, a fifth side, and a sixth side, the first side being parallel to the fourth side, the second side being parallel to the fifth side, the third side being parallel to the sixth side, a first one of the three imaginary lines being parallel to and between the first side and the fourth side, a second one of the three imaginary lines being parallel to and between the second side and the fifth side, a third one of the three imaginary lines being parallel to and between the third side and the sixth side, the three imaginary lines together presenting a substantially figure Y, thereby forming three sections each having recessed grooves that form a part of the pattern.

13. The stamp as claimed in claim 10 wherein the stamp comprises a body with a mark to indicate an orientation of the pattern.

14. The stamp as claimed in claim 10 wherein the body of the stamp extend to the end face and is a column with six faces.
